(19) United States
(12) Patent Application Publication
(10) Pub. No.: US 2013/0332111 A1
(43) Pub. Date: Dec. 12, 2013

(54) GENERATING INFORMATION CONDITIONAL ON MAPPED MEASUREMENTS

(71) Applicants: Dennis Bernard McLaughlin, Newton, MA (US); Dara Entekhabi, Cambridge, MA (US); Rafal Wojcik, Boston, MA (US); Seyed Hamed Alemohammad, Cambridge, MA (US)

(72) Inventors: Dennis Bernard McLaughlin, Newton, MA (US); Dara Entekhabi, Cambridge, MA (US); Rafal Wojcik, Boston, MA (US); Seyed Hamed Alemohammad, Cambridge, MA (US)

(73) Assignee: Massachusetts Institute of Technology, Cambridge, MA (US)

(21) Appl. No.: 13/489,762

(22) Filed: Jun. 6, 2012

(51) Int. Cl. G06F 17/18

(52) U.S. Cl. 702/181

(57) ABSTRACT

Processing a measurement includes receiving a first set of at least one measurement. The first set of at least one measurement is processed to generate conditional information corresponding to the first set of at least one measurement. The processing includes: generating a plurality of possible samples, each possible sample representing a sample from a prior probability distribution, mapping at least each measurement in the first set, and each possible sample, according to a nonlinear mapping procedure, into corresponding vectors in a target space, and generating the conditional information according to an error probability density function that is based at least in part on differences between the mapped vectors in the target space.

### STATEMENT AS TO FEDERALLY SPONSORED RESEARCH

This invention was made with government support under Contract No. 0530851 (O.S.P. Project No. 6896550) awarded by the National Science Foundation. The government has certain rights in the invention.

### BACKGROUND

In some fields information about uncertain features or phenomena is conveyed through measurements recorded by multiple sensors having different characteristics. In some cases, the measurements are represented in the form of an image. For example, seismic acoustic wave measurements are used to construct images of subsurface geological features, X-ray measurements are used to construct images of internal anatomy, and satellite microwave measurements are used to construct images of weather patterns. Different types of sensors may be susceptible to different types of noise. Also, measurements from some types of sensors are only indirectly related to the quantities of most interest. For example, a radar image that identifies the outlines of clouds gives an indirect indication of areas where there may be rain. The process of inferring information from noisy and/or indirect measurements may introduce both detection errors, which are errors in identifying the presence of a feature, and characterization errors, which are errors in describing the boundaries and internal structure of features.

### SUMMARY

In one aspect, in general, a method for processing a measurement includes receiving a first set of at least one measurement (e.g., a current measurement) stored in a storage system. The method also includes processing, with at least one processor in communication with the storage system, the first set of at least one measurement to generate conditional information corresponding to the first set of at least one measurement. The processing includes: generating a plurality of possible samples (e.g., unconditional samples), each possible sample representing a sample from a prior probability distribution, mapping at least each measurement in the first set, and each possible sample, according to a nonlinear mapping procedure, into corresponding vectors in a target space, and generating the conditional information according to an error probability density function that is based at least in part on differences between mapped vectors in the target space.

Aspects can include one or more of the following features.

Generating the conditional information includes providing a plurality of likely samples associated with the first set of at least one measurement.

Generating the conditional information includes providing at least a partial ordering for the plurality of likely samples.

Providing at least a partial ordering comprises providing respective weights for at least some of the likely samples quantifying respective likelihoods.

At least some of the weights are generated using a likelihood function that is based at least in part on the error probability density function.

Each of the likely samples corresponds to a vector in the target space, and providing the likely samples includes weighting or accepting or rejecting at least some vectors in the target space based at least in part on respective likelihoods of those vectors.

The method further includes retrieving stored historical data that includes a second set of measurements (e.g., noisy measurements) and a third set of measurements (e.g., ground truth measurements), the historical data including a plurality of groups of two or more measurements, with each group including a measurement from the second set and a corresponding measurement from the third set that characterizes errors in the measurement from the second set.

The possible samples are based at least in part on information from the historical data.

The nonlinear mapping procedure includes mapping each possible sample, each measurement in the first set, each measurement in the second set, and each measurement in the third set into corresponding vectors in the target space.

The nonlinear mapping procedure includes arranging mapped vectors in the target space so that at least some of the distances between vectors in the target space, as measured by a first similarity criterion, are substantially representative of similarities between corresponding measurements or samples from which the vectors are mapped, as measured by a second similarity criterion.

Each measurement in the first set, each measurement in the second set, each measurement in the third set, and each possible sample comprise vectors in an original space having a dimension larger than the dimension of the target space by at least a factor of ten.

A vector in the original space comprises a series of values that correspond to respective pixels in an image.

Each value corresponds to one or more segments of a segmentation of the image.

The first similarity criterion comprises a first similarity function, and the second similarity criterion comprises a second similarity function different from the first similarity function.

The second similarity criterion quantifies a degree of overlap between measurements or samples comprising binary images.

Generating the conditional information according to the error probability density function comprises: determining the error probability density function based at least in part on differences between vectors mapped from measurements in the second set and vectors mapped from corresponding measurements in the third set, and generating the conditional information associated with a particular likely sample based at least in part on evaluating the error probability density function at a difference vector that represents a difference between a vector mapped from a measurement in the first set and a vector mapped from a particular possible sample.

At least some of the plurality of likely samples have a one-to-one correspondence with respective members of the plurality of possible samples.

At least some of the plurality of likely samples are identical to respective members of the plurality of possible samples.

Each measurement in the first set is measured according to a first measurement modality, each measurement in the second set is measured according to the first measurement modality, and each measurement in the third set is measured according to a second measurement modality different from the first measurement modality.

At least some of the measurements in the third set are measured according to a combination of the second measurement modality and at least a third measurement modality different from the first and second measurement modalities.

The vectors in the target space are each associated with a tag that identifies a corresponding measurement or sample from which that vector was mapped.

The first set includes more than one measurement.

The plurality of possible samples are based at least in part on information from the first set of at least one measurement.

At least some of the plurality of possible samples preserve at least one geometric pattern of a measurement in the first set.

The plurality of possible samples represent uncertainty in a feature or phenomenon observed with the measurements in the first set.

In another aspect, in general, an apparatus for processing a measurement includes: a storage system configured to store a first set of at least one measurement; and at least one processor in communication with the storage system configured to process the first set of at least one measurement to generate conditional information corresponding to the first set of at least one measurement. The processing includes: generating a plurality of possible samples, each possible sample representing a sample from a prior probability distribution, mapping at least each measurement in the first set, and each possible sample, according to a nonlinear mapping procedure, into corresponding vectors in a target space, and generating the conditional information according to an error probability density function that is based at least in part on differences between the mapped vectors in the target space.

In another aspect, in general, a method for processing a measurement includes receiving a first set of at least one measurement (e.g., a current measurement) stored in a storage system. The method also includes processing, with at least one processor in communication with the storage system, the first set of at least one measurement based at least in part on stored historical data to generate conditional information corresponding to the first set of at least one measurement. The processing includes: retrieving the stored historical data that includes a second set of measurements (e.g., noisy measurements) and a third set of measurements (e.g., ground truth measurements), the historical data including a plurality of groups of two or more measurements, with each group including a measurement from the second set and a corresponding measurement from the third set that characterizes errors in the measurement from the second set, mapping at least each measurement in the first set, each measurement in the second set, and each measurement in the third set, according to a nonlinear mapping procedure, into corresponding vectors in a target space, and generating the conditional information according to an error probability density function that is based at least in part on differences between the mapped vectors in the target space.

Aspects can include one or more of the following features.

Generating the conditional information includes providing a plurality of likely samples associated with the first set of at least one measurement.

Generating the conditional information includes providing at least a partial ordering for the plurality of likely samples.

Providing at least a partial ordering comprises providing respective weights for at least some of the likely samples quantifying respective likelihoods.

At least some of the weights are generated using a likelihood function that is based at least in part on the error probability density function.

Each of the likely samples corresponds to a vector in the target space, and providing the likely samples includes weighting or accepting or rejecting at least some vectors in the target space based at least in part on respective likelihoods of those vectors.

The processing further includes generating a plurality of possible samples, each possible sample representing a sample from a prior probability distribution.

The method further includes mapping each possible sample, according to the nonlinear mapping procedure, into corresponding vectors in the target space.

The plurality of possible samples are based at least in part on information from the historical data.

The plurality of possible samples are based at least in part on information from the first set of at least one measurement.

Each measurement in the first set is measured according to a first measurement modality, each measurement in the second set is measured according to the first measurement modality, and each measurement in the third set is measured according to a second measurement modality different from the first measurement modality.

At least some of the measurements in the third set are measured according to the second measurement modality and at least a third measurement modality different from the first and second measurement modalities.

The vectors in the target space are each associated with a label that identifies a corresponding measurement from which that vector was mapped.

The first set includes more than one measurement.

In another aspect, in general, an apparatus for processing a measurement includes: a storage system configured to store a first set of at least one measurement; and at least one processor in communication with the storage system configured to process the first set of at least one measurement based at least in part on stored historical data to generate conditional information corresponding to the first set of at least one measurement. The processing includes: retrieving the stored historical data that includes a second set of measurements and a third set of measurements, the historical data including a plurality of groups of two or more measurements, with each group including a measurement from the second set and a corresponding measurement from the third set that characterizes errors in the measurement from the second set, mapping at least each measurement in the first set, each measurement in the second set, and each measurement in the third set, according to a nonlinear mapping procedure, into corresponding vectors in a target space, and generating the conditional information according to an error probability density function that is based at least in part on differences between the mapped vectors in the target space.

Aspects can have one or more of the following advantages.

The quality of the information derived from noisy and/or indirect measurements can be improved if the processing technique properly accounts for the distinctive errors of each measurement. This can be done by using probabilistic methods to condition members of an unconditional (or prior) ensemble of possible features or phenomena on the measurements. Uncertainties in the location, shape, and internal structure of hidden or obscured features or phenomena can be reduced with probabilistic methods that extract useful information from noisy and/or indirect current measurements while suppressing the effect of measurement errors. Some implementations of the ensemble probabilistic techniques described herein start with an unconditional ensemble (or set) of possible features or phenomena that may be represented as vectors of image pixel values defined on a specified two (or higher dimensional) grid (e.g., a spatial grid). The unconditional ensemble is modified or updated to incorporate current measurement information. The resulting modified, or conditional, ensemble is composed of a subset of likely features or phenomena that are compatible with the current measurements. The conditional ensemble is constructed either by weighting unconditional ensemble members in proportion to their probability or by accepting into the conditional ensemble likely members of the unconditional ensemble while rejecting unlikely members.

The process of identifying the most likely members of the unconditional ensemble can be performed based on a probabilistic analysis of historical measurements. In some examples, these measurements are divided into two groups, a group of historical noisy measurements of uncertain features or phenomena obtained from sensors or modalities similar to those that produce the current measurements and a group of historical ground truth measurements of the same uncertain features or phenomena obtained from sensors or modalities that are more accurate than those that produce the current measurements. Comparisons of the two paired groups of historical measurements identify the statistical characteristics of errors in the current measurements. These characteristics can be used to derive a likelihood function that is used to determine the likelihood of individual features or phenomena in the unconditional ensemble.

A particular uncertain feature or phenomenon can be characterized by a vector of pixel values that can be represented as a point in a high-dimensional image space. The processes of measurement conditioning and measurement error analysis are more feasible and effective if high-dimensional representations of the historical and current measurements and of members of the unconditional ensemble are converted to corresponding lower-dimensional attribute-based representations using a distance-based nonlinear mapping procedure. Each vector of attribute values can be represented as a point in a low-dimensional target space. Each point mapped from the image space is associated with a unique point in the target space and vice versa. For example, a tag (or label) uniquely identifies a point or vector in the image space that was mapped to a particular point or vector in the target space. The distance-based nonlinear mapping procedure arranges points in the target space so that distances between these points are, in the aggregate, similar to distances between points in the image space, distances being defined by appropriate scalar quantities that depend on the coordinates of the points.

In the lower-dimensional target space a variety of probabilistic techniques can be efficiently applied, including a non-parametric Bayesian conditioning procedure that uses a likelihood function to construct a conditional ensemble of likely features or phenomena from an unconditional ensemble of possible features or phenomena. Non-parametric Bayesian conditioning procedures are able to account for complex measurement errors such as biases and registration errors, so that the strengths and deficiencies of each measurement are properly considered. An additive Gaussian likelihood assumption (which assumes that measurements are obtained by adding Gaussian errors to the true value) is not necessary when generating the likelihood function for the non-parametric Bayesian conditioning procedure. The non-parametric approach is better able to characterize complex features and phenomena because it is able to account for displacement errors, shape distortion, backscatter, and other measurement errors that are not additive in the image space.

The likelihood function derivation and the non-parametric Bayesian conditioning procedure are both performed in the space of attribute vectors (the target space). The likelihood is computed from a measurement attribute error probability density estimated from attribute vectors mapped from the historical noisy measurements and historical ground truth measurements. Conditioning operations are performed on the attribute vectors mapped from unconditional ensemble members in the image space. Conditioning can be performed using methods such as Importance Sampling (IS) and Markov Chain Monte Carlo (MCMC) simulation. These operations can be performed very efficiently in the low-dimensional target space.

The distance-based nonlinear mapping procedure described herein is able to handle uncertainties and measurement errors that are difficult to capture using linear techniques. Image processing techniques that construct conditional image ensembles from linear combinations of different measurements tend to smear features that are disconnected, intermittent, or clustered in space. Linear techniques may also have difficulty accounting for complex non-additive measurement errors. The nonlinear mapping and measurement conditioning techniques described herein are able to deal with complex spatial structure while properly accounting for measurement uncertainty.

Other features and advantages of the invention are apparent from the following description, and from the claims.

### DESCRIPTION OF DRAWINGS

FIG. 1 is a block diagram of a measurement processing system.

FIG. 2 is an illustration of an example of rainfall measurements.

FIG. 3 is a schematic diagram of a measurement processing procedure.

FIG. 4 is a flowchart of a measurement processing procedure.

### DESCRIPTION

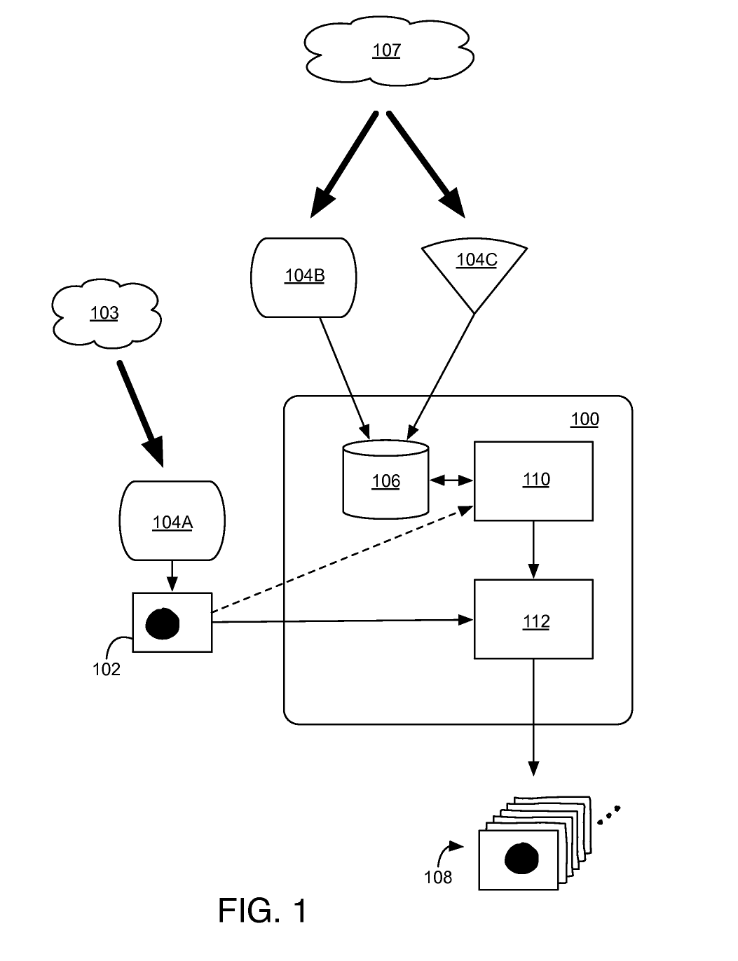

FIG. 1 shows an example of a measurement processing system 100 that can be used to process a measurement 102 of some feature or phenomenon 103 based on historical data that includes measurements of similar features or phenomena. The measurement 102 is measured by a measuring device 104A. For example, the measurements can be associated with uncertain, hidden or obscured objects or phenomena of interest in medicine (e.g., for detecting and diagnosing tumors), environmental sensing (e.g., for meteorological investigation, geographical analysis, or oil/gas exploration), military surveillance, astronomy, or robotics. The system 100 is described below with reference to an environmental remote sensing example.

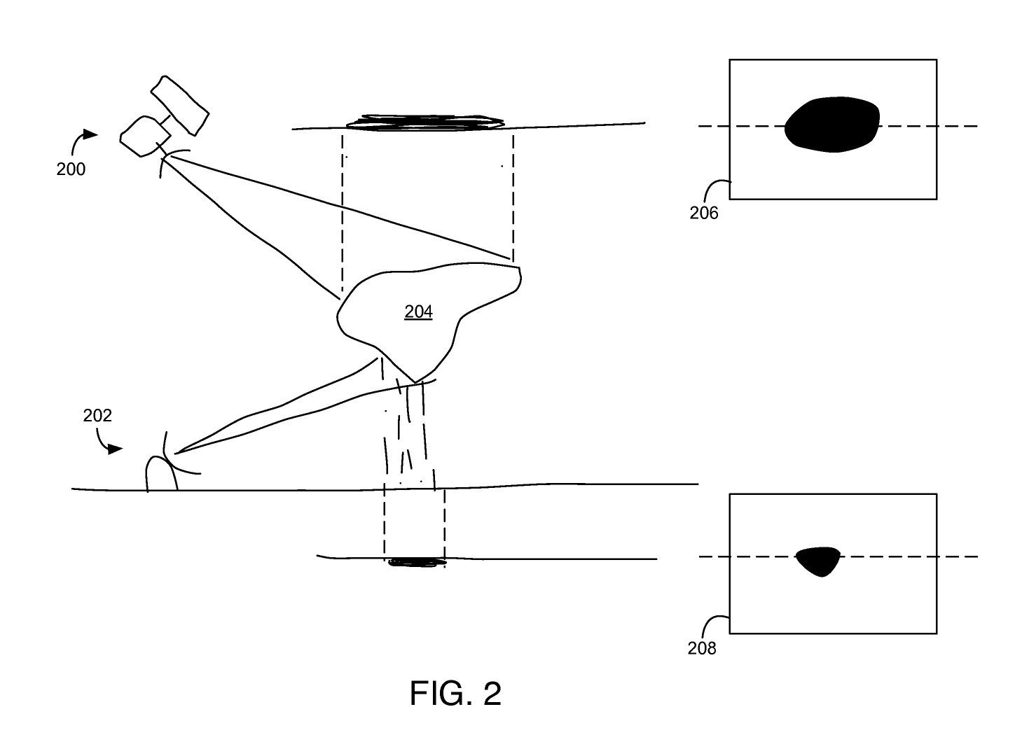

For some fields, such as remote sensing for meteorological investigation, some measurement modalities provide more accurate results than other measurement modalities. For example, one modality may use a more accurate sensing mechanism that has limited coverage while another modality may have wider coverage but is less accurate. Referring to FIG. 2, a satellite-based radar system 200 may be able to generate radar images of a cloud formation 204 that provide an indication of where it could be raining in a particular area. Whereas, a ground-based radar system 202 may be able to generate radar images that more precisely indicate where the rainfall is actually located in that area. In this example, an image 206 produced by the satellite-based radar system 200 shows a region of likely rainfall based on the top of a cloud layer that was visible from above. An image 208 produced by the ground-based radar system 202 shows a region of rainfall based on detection of features from below that are more closely correlated with the actual precipitation. The images generated by both systems may undergo some initial processing to extract useful information such as a binary segmentation process that yields a binary image indicating locations where rainfall is likely to be present, as described in more detail below. Both images 206 and 208 are measurements of the same phenomenon, but the image 208 is more accurate and can therefore be used to characterize errors in the other image 206. There may be any number of measurement modalities used to capture a set of measurements of the same phenomenon, some of which may be highly accurate but limited in certain ways. For example, a third modality for measuring rainfall is the use of rain gauges that accurately record the amount of rainfall, but only at specific isolated points. Information from multiple modalities can be combined or conditioned on each other to represent a closer approximation to reality for any given set of measurements.

Referring again to FIG. 1, historical data are stored in a data storage system 106 (e.g., a database system) of the system 100. The historical data include multiple sets of grouped measurements. Different sets of measurements may have been obtained at different times (e.g., over days, months, or years), or at different locations (e.g., images from one or more satellites aimed at different parts of the Earth). In addition, different measurements may have different costs, coverage, resolution, and accuracy. For certain fields (e.g., medical imaging) the sets of measurements may correspond to different subjects (e.g., human subjects, or animal subjects). Each group of measurements includes multiple measurements of particular features or phenomena that were recorded using different respective measurement modalities. In this example, measuring device 104B produces one or more noisy measurements (e.g., a satellite-based microwave signal) that are similar to those obtained from measurement device 104A. These noisy measurements may be attractive because they have better coverage, are less expensive, or are more readily available than more accurate measurements. The measuring device 104C produces at least one more accurate ground truth measurement (e.g., a ground-based radar signal) of the same feature or phenomenon 107 measured by devices 104B. A comparison of the images produced by 104B and 104C provides useful information about errors that are present in the noisy measurements from 104B but not in the more accurate measurement from 104C. In some applications the ground truth measurement may be synthesized from a combination of multiple measurement modalities (e.g., ground-radar supplemented by or conditioned on rain gauges) in order to provide an even more accurate ground truth representation. The grouped noisy and ground truth measurements from 104B and 104C need not be available everywhere or at all times. They may only be needed at enough times and locations to provide information about the nature of errors in the noisy measurements.

The measurement processing system 100 processes current measurements 102 acquired by measuring devices, such as device 104A, that use the same (or substantially similar) measurement modalities as the modalities of the measuring device 104B that produces the noisy historical measurements stored in the data storage system 106. The purpose of the processing system is to combine all the current measurements so that the most informative aspects of each can be extracted. The information on measurement errors derived from historical noisy and ground truth measurements in the data storage system provide the basis for combining current measurements with different properties.

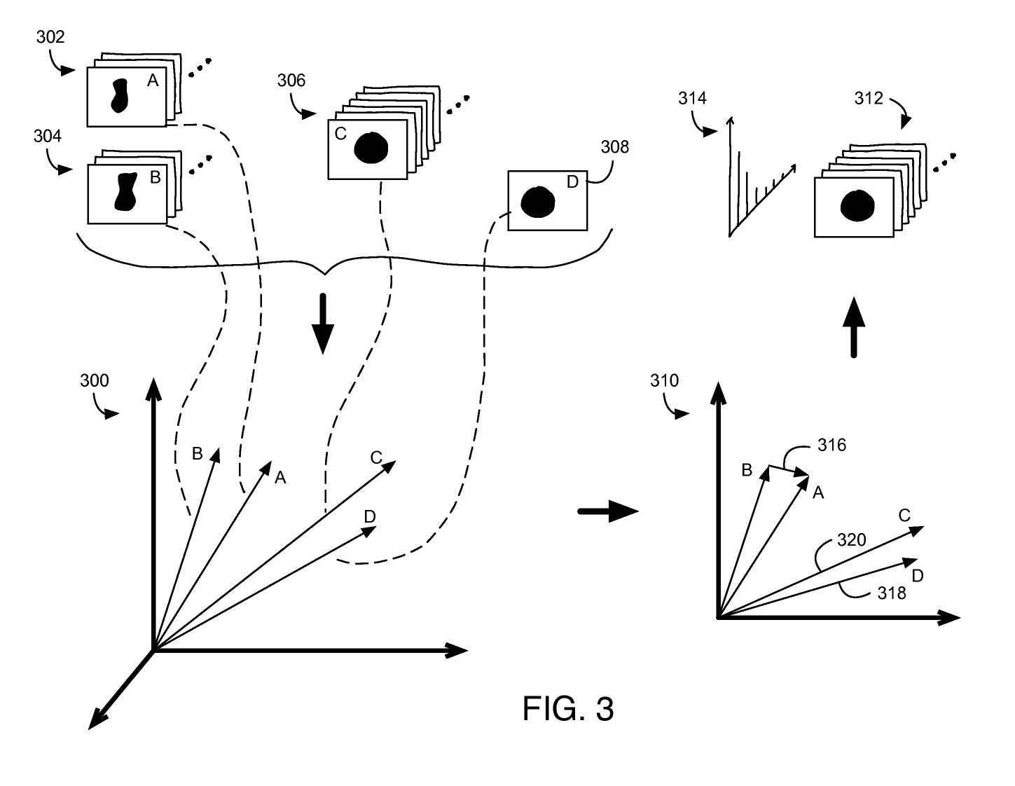

The current measurement 102, the historical measurements in the data storage module 106, and the unconditional ensemble 306 of possible features and phenomena (described below with reference to FIG. 3) can all be represented as high-dimensional vectors of pixel values. In the meteorological example, images of weather features (e.g. from a low orbiting satellite) may be stored as high-resolution M×M pixel digital images in two spatial dimensions (e.g., on the order of 100×100=10,000 pixels) with pixel values that potentially code gray scale intensity or color. In a meteorological application, the module 110 can optionally perform a segmentation process to partition the images into two possibly disconnected regions, e.g. one representing areas with rain, and the other representing areas without rain. In such cases, an intensity threshold can be used to decide whether a given pixel is in the rain or no-rain region (in some cases, after applying some initial filtering to the image). Similar examples apply in petroleum applications, where categorical distinctions can be made between various geological facies, or in medical applications where distinctions can be made between malignant and non-malignant cells. The resulting 2-D array of M×M binary image values can be represented as a 1-D vector of M² binary values.

The processing module 112 performs a nonlinear mapping of the high-dimensional (e.g. 10,000 dimensional) vectors of pixel values to substantially lower-dimensional attribute vectors (e.g., by one or more orders of magnitude, or to a space having relatively few dimensions, such as a 2 dimensional space). The set of all possible high-dimensional pixel value vectors defines the image space. The set of all possible low-dimensional attribute vectors defines the target space. The nonlinear mapping automatically extracts informative attributes that distinguish different features and phenomena. The attributes do not need to be specified in advance but are inferred directly from all of the mapped data These data are the current measurement 102, the historical noisy and ground truth measurements in the data storage system 106, and the members of the unconditional ensemble 306. Since the target space is low-dimensional, probabilistic analyses that would otherwise be impractical or intractable can be performed efficiently on the mapped attribute vectors. A possible option for the non-linear mapping procedure is multi-dimensional scaling. Multi-dimensional scaling has a number of variants. Examples of the general approach are described in more detail below.

The system 100 includes a processing module 112 that generates, in the target space, a conditional ensemble 108 of attribute vectors by combining attribute information derived from the current measurements 102 with attribute information derived from an unconditional ensemble 306 of realistic candidate features and phenomena. The system 100 also includes a pre-processing module 110 that generates the unconditional ensemble 306, as described in more detail below. Each member of the unconditional ensemble 306 is initially assigned equal weight, implying that all members initially have the same probability. The current measurement 102, the historic noisy and ground truth measurements in the data storage system 106, and the members of the unconditional ensemble 306 in the image space are all mapped to the target space via the nonlinear mapping procedure performed by the processing module 112. The processing module 112 is able to perform a Bayesian conditioning procedure entirely in the target space. In one example, this procedure reweights each member of the unconditional attribute vector ensemble (e.g., importance sampling). In another example, this procedure accepts or rejects the members of the unconditional attribute vector ensemble, giving all accepted members the same weight (e.g., Markov Chain Monte Carlo). Possible features and phenomena tagged to the members of the resulting conditional attribute ensemble 108 are compatible with the current measurement(s) 102. In the Bayesian conditioning procedure compatibility is measured by a non-parametric attribute likelihood function derived from historic noisy and ground truth images stored in the data storage system 106. If the measurement 102 is very accurate, a few of the conditional ensemble images may receive large weights, indicating that they are most likely to be close to the unobserved “truth.” If the measurement 102 is less accurate, the weights for the conditional ensemble members may be more evenly distributed among a larger number of possible images. Further processing can be performed based on these weights to focus on a small number of most likely features or phenomena or to identify the risk of less likely extreme events (e.g., determining whether an observed weather pattern corresponds to a storm).

The pre-processing module 110 can optionally use a multi-point geostatistical procedure to generate an unconditional ensemble of realistic features or phenomena. Each member of the unconditional ensemble is a random sample optionally constrained to reproduce a subset of points in the current measurement image 102. The unconditional image generation procedure can also be designed so that the random samples reproduce statistics derived from training images constructed from the historical measurements in the data storage system 106. This approach insures that the unconditional samples resemble the current measurement in a general way while allowing for variability revealed in the data storage system. The generation procedure can be constructed so that it produces a large number of likely vectors and a smaller number of unlikely vectors so that resolution is highest in portions of the pixel space containing high probability images. The members of the unconditional ensemble provide a non-parametric representation of a Bayesian prior probability distribution.

Other methods may be used to generate the unconditional ensemble. In some implementations, samples in the ensemble can be generated from historical measurements contained in the data storage system 106 (e.g., from the ground truth measurements). The number of samples included in the unconditional ensemble can be larger than the number of historical measurements in the data storage system 106.

The pre-processing module 110 optionally performs transformations on the historical data in addition to generating the unconditional ensemble. The results of the pre-processing can be stored back into the data storage system 106 until they are needed, or provided to the processing module 112 for storage and/or direct processing. In some implementations, the transformations and/or the ensemble generation of the pre-processing module 110 are performed well before the measurement 102 has been acquired. In other arrangements of the system 100, the functions of the pre-processing module 110 have already been performed by a different system and the results of the transformations and/or ensemble generation are already included in the stored historical data, or the functions of the pre-processing module 110 are performed by the processing module 112 after the measurement 102 has been acquired. The modules 110 and 112 may be implemented in different respective computing systems in communication with each other (e.g., over a network), or may be integrated together within the same computing system. The data storage system 106 may also be in communication with either or both of the modules 110 and 112 or integrated together in the same computing system as either or both modules.

The nonlinear mapping from the image space to the target space can optionally be designed to preserve, as closely as possible, specified measures of the distance between images. That is, the scaled distance between any two attribute vectors in the target space is as close as possible to the scaled distance between the corresponding two members of the image space (i.e., two vectors of pixel values) in the image space. In some implementations, the scalar quantity used to measure distance in the target space is different from the quantity used to measure distance in the image space. For example, the quantity used to measure distance in the image space could quantify the amount of overlap between nonzero segments of the binary images generated by the module 110. By contrast, the quantity used to measure distance in the target space could be an Eulidean metric (square root of the sum of squared attributes)

Referring to FIG. 3, the processing module 112 performs the nonlinear mapping procedure to map vectors in an image space 300 into vectors in a target space 310. This example, for simplicity of visualization, shows vectors in a 3-D image space 300 being mapped to vectors in a 2-D target space 310, but in typical examples the number of dimensions of the image space would be much larger (e.g. 10,000 or more). The number of dimensions in the target space can be relatively small to facilitate efficient Bayesian probabilistic calculations in that space (e.g., a number of dimensions of 2 or 3, or less than around 10).

The processing module 112 receives different types of image space vectors to be mapped into attribute vectors. Each image space member is represented as as a tagged vector. The tags enable the identity of each member of the image to be tracked throughout the mapping procedure so that an attribute vector can be linked back to a corresponding image space vector, without requiring the mapping to be reversed or inverted. In this example, a binary image A from the noisy historical measurement set 302 (104B in FIG. 1) corresponds to a vector A in the image space 300, and a binary image B from the ground truth historical measurement set 304 (104C in FIG. 1) corresponds to a vector B in the same image space 300. A similar tagging and mapping approach is used for the members of the unconditional ensemble 306, such as image C, and the current measurement image 308 (102 in FIG. 1), such as image D.

The mapping procedure 112 uses a multidimensional scaling technique to generate low-dimensional attribute value vectors in the target space 310 that each correspond to one of the high-dimensional pixel value vectors in the image space 300. The attribute vectors are arranged, through an iterative optimization procedure, to have distances that are substantially representative of similarities between corresponding image space vectors. For example, the processing module 112 selects initial attribute vectors and iteratively adjusts the positions of the attribute vectors in the target space so that “distances” between any given pair of attribute value vectors are progressively closer to the “distances” between the corresponding image space vectors. The “distances” in the two spaces may be defined in a number of different ways. One option for quantifying distance in the image space is the Jaccard distance, described in more detail below. The method used to quantify distance in the target space can be different such as, for example, a Euclidean norm or a weighted Euclidian norm (e.g., the Mahalonobis distance) of the algebraic difference between two attribute vectors. The attribute vectors are also tagged to identify the corresponding image space vectors from which they were mapped.

The processing module 112 generates a conditional ensemble of attribute vectors based on Bayes theorem. In FIG. 3, the conditional ensemble 312 of possible samples is optionally accompanied by a corresponding set of weights 314 that rank the samples in the ensemble. These weights, which are used with an importance sampling implementation of Bayesian conditioning, are derived from the likelihood function. If a Markov Chain Monte Carlo approach is adopted the likelihood function is used to accept or reject samples from the unconditional ensemble (or from a related proposed ensemble of possible images). In this case the weights of all accepted samples are the same.

The likelihood function is derived by assuming that measurement errors are additive in the target space (but not necessarily in the image space). In this case, the likelihood function for a given unconditional (or proposal) sample and a given current measurement is the probability of a measurement error equal to the algebraic difference between the sample and the measurement. The measurement error probability may be estimated from differences between attribute value vectors mapped from the noisy measurements 302 and attribute vectors mapped from the corresponding historical ground truth measurements 304. For example, for the pair of measurements A and B, the magnitude of the difference vector 316 in the target space gives one particular measurement error in the target space. Various approximation techniques can be used to estimate the likelihood function from the set of all measurement errors in this space. For example, a smooth possibly multi-modal kernel density function can be fit to these errors.

If the estimated measurement error probability density is represented by p_{\hat{ε}}[\hat{ε}], where \hat{ε} is a particular measurement error attribute value vector, the current measurement attribute vector is represented by \hat{Z}, and \hat{X} represents a particular sample from the unconditional ensemble them the associated target space likelihood function value is p_{\hat{Z}|\hat{X}}[\hat{Z}|\hat{X}]≈p_{ε}[\hat{Z}−\hat{X}]. An example of a calculation using this function is described in more detail below.

The role of the Bayesian conditioning module 114 is somewhat different for importance sampling and Markov Chain Monte Carlo procedures. These procedures should produce probabilistically equivalent conditional ensembles when the ensemble size is sufficiently large but they may differ when sample sizes are relatively small. In such cases the best option depends on the application. Other possible options that can also be used to generate approximate conditional ensembles include Gibbs sampling, rejection sampling, and simulated annealing. If an importance sampling approach is adopted the weight for each unconditional ensemble member is proportional to the likelihood function evaluated at the difference between the ensemble member attribute vector and the current measurement attribute vector. If a Markov Chain Monte Carlo approach is adopted the probability of including a particular unconditional (or proposal) member in the conditional ensemble (i.e. the acceptance probability) is proportional to the same likelihood value.

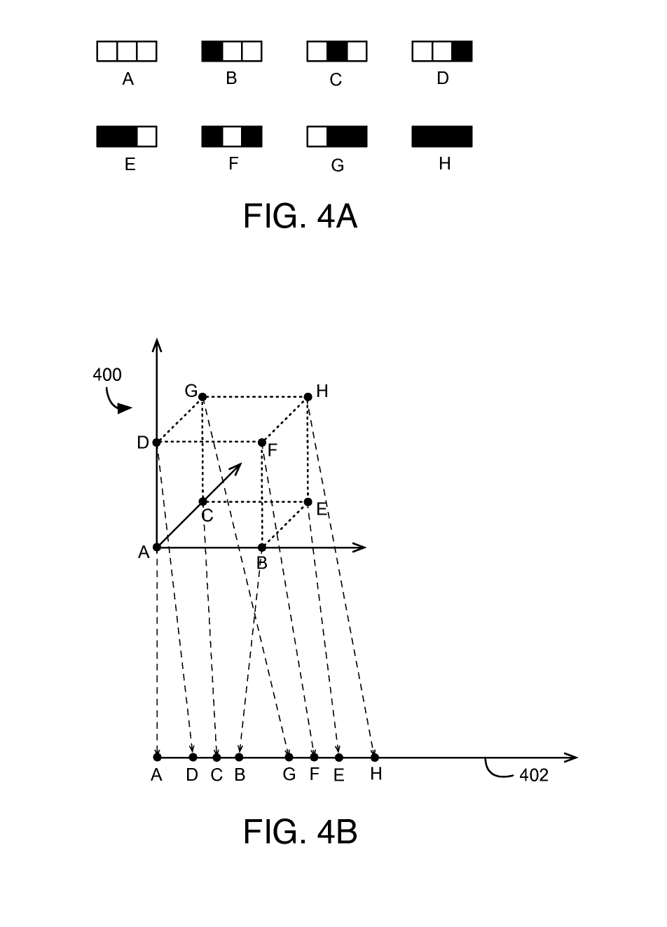

The example described below illustrates the nonlinear procedure for mapping vectors from the image space to a target space where the unconditional ensemble is conditioned with importance sampling. In this example, the possible members of the image space are images composed of M discrete pixels characterized by binary values of either 0 (e.g., representing no rain) or 1 (e.g., representing rain). Therefore, there are L=2^{M} possible binary images. Each possible image may be represented as a vector of M values that defines one of L possible points in an M-dimensional image space. For example, referring to FIGS. 4A and 4B, the set of all possible 3-pixel images tagged A-H (FIG. 4A) can be represented as vectors that define L=2³=8 points (also tagged A-H) in a 3-D space 400 (FIG. 4B). These vectors in the higher dimensional (3-dimensional) image space can be mapped to points in the lower-dimensional (1-dimensional) target space.

The equally likely (equal weight) members of the unconditional image space ensemble are expressed as: Xᵢ, i=1, . . . , N. These pixel-based vectors (called “replicates”) are generated from information conveyed in one or more training images. For example, the ensemble generating module 110 can be configured to use a multipoint random field generator, possibly constrained by historical data from a store of previously recorded measurements. The distribution of N replicates in the unconditional ensemble of the example implicitly defines an unconditional, or prior, probability distribution over the finite but possibly very large set of all possible binary images. A finite distribution of N<L replicates will not necessarily include the true image, but the unconditional ensemble should include at least some images that are close to the true image (with respect to a specified similarity measure) with non-zero probability, if N>>L.

The historical noisy measurements, are expressed as vectors of pixel values Uⱼ, j=1, . . . , J. in the image space. The historical ground truth measurements are expressed as vectors of pixel values Vⱼ, j=1, . . . , J in the image space For each value of j, the measurement Vⱼ represents a more accurate measurement used as a surrogate for the feature or phenomenon that produced the measurement Uⱼ. These historical noisy measurements Uⱼ and historical ground truth measurements Vⱼ together define the measurement errors used to derive the target space likelihood function.

The nonlinear mapping procedure associates each image in the high-dimensional image space with a corresponding vector in the low-dimensional target space. This can be represented by the expression: [\hat{X}, \hat{Z}, Û, \hat{V}]=T[X, Z, U, V], where X is a vector containing all members of the unconditional ensemble, Z is the current measurement, U is a vector containing all the Uⱼ noisy measurements, and V is a vector containing all the Vⱼ ground truth measurements. The quantities \hat{X}, \hat{Z}, Û and \hat{V} represent the corresponding vectors of attribute values. The large vector [X, Z, U, V] defines a set of points in the high-dimensional image space. The much smaller vector [\hat{X}, \hat{Z}, Û, \hat{V}] defines a corresponding set of points in the low dimensional target space. The mapping T generates [\hat{X}, \hat{Z}, Û, \hat{V}] from [X, Z, U,V].

When formulated in the target space, Bayes rule specifies that the conditional probability density function (PDF) of any image attribute vector \hat{χ} given \hat{Z} is: p(\hat{χ}|\hat{Z})=cp(\hat{Z}|\hat{χ})p(\hat{χ}), where c is selected so that this conditional PDF integrates to 1. In classical probability theory p(\hat{χ}) is the unconditional (or prior) PDF for \hat{χ} and p(\hat{Z}|\hat{X}ᵢ) is the likelihood function, which describes the probability that a particular measurement \hat{Z} will be obtained when the true image has attributes \hat{χ}. In this example, the likelihood function accounts for the effect of measurement errors.

The ensemble approach approximates the unconditional and conditional PDFs with following discrete ensemble approximations for p(\hat{χ}) and p(\hat{χ}|\hat{Z}):

$$p ( \hat{χ} ) = {\sum }_{i = 1}^{N} {w}_{ui} δ ( \hat{χ} - {\hat{X}}_{i} )$$

$$p ( \hat{χ} \vert \hat{Z} ) = {\sum }_{i = 1}^{N} {w}_{ci} δ ( \hat{χ} - {\hat{χ}}_{i} )$$

where:

wᵤᵢ=Unconditional weight (or discrete probability) of replicate Xᵢ, and

w_{ci}=Conditional weight (or discrete probability) of Xᵢ.

These PDF approximations imply that the only possible image attribute vectors are those in the unconditional ensemble. The replicate weights are selected to ensure that the following normalization condition holds:

$${\sum }_{i = 1}^{N} {w}_{ui} = {\sum }_{i = 1}^{N} {w}_{ci} = 1$$

In this example, the processing module 112 generates the conditional weight for each replicate. Those replicates with the highest weights are most probable. When all the unconditional replicates have equal probability the unconditional weights are:

$${w}_{ui} = \frac{1}{N} ∀ i$$

Then, for each replicate, Bayes rule gives the following conditional weight:

$${w}_{ci} = \frac{c}{N} p ( \hat{Z} \vert {\hat{X}}_{i} )$$

When c is chosen to ensure that the conditional weights sum to 1 the following expression results:

$${w}_{ci} = \frac{p ( \hat{Z} \vert {\hat{X}}_{i} )}{{\sum }_{i = 1}^{N} p ( \hat{Z} \vert {\hat{X}}_{i} )}$$

With this formulation, called importance sampling, the posterior weights assigned to the replicates depend only on the likelihoods p(\hat{Z}|\hat{X}ᵢ) i=1, . . . , N. In essence, the importance sampling process reweights each replicate, replacing the unconditional weight by a conditional weight that is proportional to the replicate likelihood value. The likelihood measures the “distance” between the replicate and measurement in a way that accounts for measurement error.

The system 100 is able to discriminate between images with a relatively small number of attributes by performing the nonlinear mapping procedure to ensure that two attribute vectors Ŷᵢ and Ŷⱼ (tagged by the indices i and j) are sensitive to important differences in the corresponding members Yᵢ and Yⱼ of the image space. Differences are quantified with appropriate distance measures, which may be different in the image and target spaces.

One distance measure option is the Mahalonobis distance, which is a metric induced by the weighted Euclidean norm. For example, the Mahalonobis distance between a measurement attribute vector \hat{Z} and a replicate vector \hat{X}ᵢ is:

d_{M}(Z,Xᵢ)=∥Z−Xᵢ∥_{C}=[(Z−Xᵢ)^{T}C⁻¹(Z−Xᵢ)]^{1/2}

where C is a positive definite matrix that weights contributions from various elements (or pixels) of the two image vectors.

Other distance measures may provide a better ability to discriminate between measured or unconditional ensemble images that are visually quite different. For example, an alternative distance measure option is the Jaccard similarity measure d_{Jac}(Z, Xᵢ). In the case of binary image space vectors, this distance is defined as:

$${d}_{Jac} ( Z , {X}_{i} ) = \frac{\vert Z ⋃ {X}_{i} \vert - \vert Z ⋂ {X}_{i} \vert}{\vert Z ⋃ {X}_{i} \vert} = \frac{{M}_{01} + {M}_{10}}{{M}_{01} + {M}_{10} + {M}_{11}}$$

where M₁₁ is the number of pixels that are 1 in both images, M₀₁ is the number of pixels with a value 0 in Z and 1 in Xᵢ, and M₁₀ is the number of pixels with a value 1 in Z and 0 in Xᵢ. This distance is 0.0 when the images perfectly coincide and 1.0 when they do not overlap anywhere. The Jaccard distance provides reasonable image discrimination because it is sensitive to the overlap between images. Overlap is one of the more visually conspicuous ways to distinguish two binary images.

The nonlinear mapping procedure can be performed such that the image space-to-target space transformation T(•) (approximately) preserves distances between points (or vectors) in the measurement and target spaces. For example, the procedure iteratively adjusts the locations (attribute values) of points in the target space so that distances between points in the target space are approximately the same as distances between corresponding points in the measurement space. Distances in the measurement space can be defined according to a Jaccard similarity function (or other similarity function), and distances in the target space are defined according to a Mahalanobis distance metric (or other similarity function).

Since the nonlinear mapping procedure considers all relevant images (current and historical measurements as well as replicates) it provides an aggregate “best” attribute characterization for the entire image set, rather than for any single image. The quality of this characterization can be expected to improve, up to a point, as more attributes are added (e.g., as the number of dimensions of the target space is increased). At some point increasing the number of attributes will no longer improve accuracy because the target space Bayesian conditioning procedure typically requires a larger number of samples to give satisfactory results when the target space dimension is large. The Jaccard-based distance preserving nonlinear mapping procedure makes it feasible to carry out non-parametric Bayesian conditioning problem with a practical number of samples in a low-dimensional target space.

In image processing applications it is helpful for the replicates to represent plausible image candidates that share important features with the unknown true image. At the same time, they should be sufficiently different from one another to properly represent uncertainty. It is possible to balance these requirements by generating unconditional replicates from an appropriate training image (or images). A generation procedure that depends on training images produces random replicates that reproduce general features of the training images. One such procedure is the multipoint geostatistical generator implemented in the open source SNESIM package available from Stanford University. In this case the generator scans the training image(s) with a set of nested templates. Probabilities of particular binary patterns (e.g., of non-zero value “rain pixels” vs. zero value “no rain pixels”) within the templates are computed from the number of instances of each possible pattern.

If the probabilities used in the unconditional replicate generator are unconstrained non-zero features within the image tend to be distributed more or less uniformly through space, reflecting the ergodicity assumption that is implicitly imposed when the template is used to convert spatial frequencies to ensemble probabilities. Such stationary distributions are generally unrealistic since non-zero features are often localized in one section of the image rather than distributed uniformly through space. It is possible to obtain a more realistic nonstationary ensemble if the replicates are constrained to reproduce (either with certainty or with a specified probability) the values of specified pixels within the current measurement image Z.

It is reasonable to constrain the unconditional replicates to reproduce some aspects of the current measurement because it is likely that non-zero binary features in the unknown true image lie more or less in the same region as non-zero features in the measurement. Although constraining unconditional replicates is helpful, it is best to limit the number of constraining pixels so that there is sufficient diversity among the unconditional replicates to properly reflect uncertainty. The fraction of constraining current measurement pixels serves as a design parameter. As this fraction is adjusted from small to large, the replicates become more similar to each other and to the current measurement.

The techniques described herein can be extended in various ways. For example, both images and the corresponding attribute vectors can be time dependent for use in dynamic applications where current and historical measurements may change over time (e.g., as in a time series of images or video).

It is to be understood that the foregoing description is intended to illustrate and not to limit the scope of the invention, which is defined by the scope of the appended claims. Other embodiments are within the scope of the following claims.

What is claimed is:

1. A method for processing a measurement, the method comprising:
receiving a first set of at least one measurement stored in a storage system; and
processing, with at least one processor in communication with the storage system, the first set of at least one measurement to generate conditional information corresponding to the first set of at least one measurement, the processing including
generating a plurality of possible samples, each possible sample representing a sample from a prior probability distribution,
mapping at least each measurement in the first set, and each possible sample, according to a nonlinear mapping procedure, into corresponding vectors in a target space, and
generating the conditional information according to an error probability density function that is based at least in part on differences between the mapped vectors in the target space.

2. The method of claim 1, wherein generating the conditional information includes providing a plurality of likely samples associated with the first set of at least one measurement.

3. The method of claim 2, wherein generating the conditional information includes providing at least a partial ordering for the plurality of likely samples.

4. The method of claim 3, wherein providing at least a partial ordering comprises providing respective weights for at least some of the likely samples quantifying respective likelihoods.

5. The method of claim 4, wherein at least some of the weights are generated using a likelihood function that is based at least in part on the error probability density function.

6. The method of claim 2, wherein each of the likely samples corresponds to a vector in the target space, and providing the likely samples includes weighting or accepting or rejecting at least some vectors in the target space based at least in part on respective likelihoods of those vectors.

7. The method of claim 2, further including retrieving stored historical data that includes a second set of measurements and a third set of measurements, the historical data including a plurality of groups of two or more measurements, with each group including a measurement from the second set and a corresponding measurement from the third set that characterizes errors in the measurement from the second set.

8. The method of claim 7, wherein the plurality of possible samples are based at least in part on information from the historical data.

9. The method of claim 7, wherein the nonlinear mapping procedure includes mapping each possible sample, each measurement in the first set, each measurement in the second set, and each measurement in the third set into corresponding vectors in the target space.

10. The method of claim 9, wherein the nonlinear mapping procedure includes arranging mapped vectors in the target space so that at least some of the distances between vectors in the target space, as measured by a first similarity criterion, are substantially representative of similarities between corresponding measurements or samples from which the vectors are mapped, as measured by a second similarity criterion.

11. The method of claim 10, wherein each measurement in the first set, each measurement in the second set, each measurement in the third set, and each possible sample comprise vectors in an original space having a dimension larger than the dimension of the target space by at least a factor of ten.

12. The method of claim 11, wherein a vector in the original space comprises a series of values that correspond to respective pixels in an image.

13. The method of claim 12, wherein each value corresponds to one or more segments of a segmentation of the image.

14. The method of claim 10, wherein the first similarity criterion comprises a first similarity function, and the second similarity criterion comprises a second similarity function different from the first similarity function.

15. The method of claim 10, wherein the second similarity criterion quantifies a degree of overlap between measurements or samples comprising binary images.

16. The method of claim 9, wherein generating the conditional information according to the error probability density function comprises:
determining the error probability density function based at least in part on differences between vectors mapped from measurements in the second set and vectors mapped from corresponding measurements in the third set, and
generating the conditional information associated with a particular likely sample based at least in part on evaluating the error probability density function at a difference vector that represents a difference between a vector mapped from a measurement in the first set and a vector mapped from a particular possible sample.

17. The method of claim 9, wherein at least some of the plurality of likely samples have a one-to-one correspondence with respective members of the plurality of possible samples.

18. The method of claim 17, wherein at least some of the plurality of likely samples are identical to respective members of the plurality of possible samples.

19. The method of claim 1, wherein each measurement in the first set is measured according to a first measurement modality, each measurement in the second set is measured according to the first measurement modality, and each measurement in the third set is measured according to a second measurement modality different from the first measurement modality.

20. The method of claim 19, wherein at least some of the measurements in the third set are measured according to a combination of the second measurement modality and at least a third measurement modality different from the first and second measurement modalities.

21. The method of claim 1, wherein the vectors in the target space are each associated with a tag that identifies a corresponding measurement or sample from which that vector was mapped.

22. The method of claim 1, wherein the first set includes more than one measurement.

23. The method of claim 1, wherein the plurality of possible samples are based at least in part on information from the first set of at least one measurement.

24. The method of claim 23, wherein at least some of the plurality of possible samples preserve at least one geometric pattern of a measurement in the first set.

25. The method of claim 23, wherein the plurality of possible samples represent uncertainty in a feature or phenomenon observed with the measurements in the first set.

26. An apparatus for processing a measurement, the apparatus comprising:
a storage system configured to store a first set of at least one measurement; and
at least one processor in communication with the storage system configured to process the first set of at least one measurement to generate conditional information corresponding to the first set of at least one measurement, the processing including
generating a plurality of possible samples, each possible sample representing a sample from a prior probability distribution,
mapping at least each measurement in the first set, and each possible sample, according to a nonlinear mapping procedure, into corresponding vectors in a target space, and
generating the conditional information according to an error probability density function that is based at least in part on differences between the mapped vectors in the target space.

27. A method for processing a measurement, the method comprising:
receiving a first set of at least one measurement stored in a storage system; and
processing, with at least one processor in communication with the storage system, the first set of at least one measurement based at least in part on stored historical data to generate conditional information corresponding to the first set of at least one measurement, the processing including
retrieving the stored historical data that includes a second set of measurements and a third set of measurements, the historical data including a plurality of groups of two or more measurements, with each group including a measurement from the second set and a corresponding measurement from the third set that characterizes errors in the measurement from the second set,
mapping at least each measurement in the first set, each measurement in the second set, and each measurement in the third set, according to a nonlinear mapping procedure, into corresponding vectors in a target space, and
generating the conditional information according to an error probability density function that is based at least in part on differences between the mapped vectors in the target space.

28. The method of claim 27, wherein generating the conditional information includes providing a plurality of likely samples associated with the first set of at least one measurement.

29. The method of claim 28, wherein generating the conditional information includes providing at least a partial ordering for the plurality of likely samples.

30. The method of claim 29, wherein providing at least a partial ordering comprises providing respective weights for at least some of the likely samples quantifying respective likelihoods.

31. The method of claim 30, wherein at least some of the weights are generated using a likelihood function that is based at least in part on the error probability density function.

32. The method of claim 28, wherein each of the likely samples corresponds to a vector in the target space, and providing the likely samples includes weighting or accepting or rejecting at least some vectors in the target space based at least in part on respective likelihoods of those vectors.

33. The method of claim 28, wherein the processing further includes generating a plurality of possible samples, each possible sample representing a sample from a prior probability distribution.

34. The method of claim 33, further comprising mapping each possible sample, according to the nonlinear mapping procedure, into corresponding vectors in the target space.

35. The method of claim 33, wherein the plurality of possible samples are based at least in part on information from the historical data.

36. The method of claim 33, wherein the plurality of possible samples are based at least in part on information from the first set of at least one measurement.

37. The method of claim 27, wherein each measurement in the first set is measured according to a first measurement modality, each measurement in the second set is measured according to the first measurement modality, and each measurement in the third set is measured according to a second measurement modality different from the first measurement modality.

38. The method of claim 37, wherein at least some of the measurements in the third set are measured according to the second measurement modality and at least a third measurement modality different from the first and second measurement modalities.

39. The method of claim 27, wherein the vectors in the target space are each associated with a label that identifies a corresponding measurement from which that vector was mapped.

40. The method of claim 27, wherein the first set includes more than one measurement.

41. An apparatus for processing a measurement, the apparatus comprising:
a storage system configured to store a first set of at least one measurement; and
at least one processor in communication with the storage system configured to process the first set of at least one measurement based at least in part on stored historical data to generate conditional information corresponding to the first set of at least one measurement, the processing including
retrieving the stored historical data that includes a second set of measurements and a third set of measurements, the historical data including a plurality of groups of two or more measurements, with each group including a measurement from the second set and a corresponding measurement from the third set that characterizes errors in the measurement from the second set,
mapping at least each measurement in the first set, each measurement in the second set, and each measurement in the third set, according to a nonlinear mapping procedure, into corresponding vectors in a target space, and
generating the conditional information according to an error probability density function that is based at least in part on differences between the mapped vectors in the target space.
